(19) United States
(12) Patent Application Publication
(10) Pub. No.: US 2024/0045487 A1
(43) Pub. Date: Feb. 8, 2024

(54) ELECTRICAL EVENT RECOVERY SYSTEM AND METHOD

(71) Applicant: Schneider Electric USA, Inc., Andover, MA (US)

(72) Inventor: Jon A. Bickel, Murfreesboro, TN (US)

(73) Assignee: Schneider Electric USA, Inc., Boston, MA (US)

(21) Appl. No.: 18/078,516

(22) Filed: Dec. 9, 2022

Related U.S. Application Data
(60) Provisional application No. 63/395,651, filed on Aug. 5, 2022.

(51) Int. Cl. G06F 1/30; H02J 3/00; H02J 13/00

(52) U.S. Cl. CPC G06F 1/30; H02J 3/001; H02J 13/00002; H02J 13/00006

(57) ABSTRACT

Systems and methods for providing event recovery information and data in an electrical system are disclosed herein. In one example implementation, a method for providing event recovery information and data in an electrical system includes processing electrical measurement data from or derived from energy-related signal(s) captured or derived by at least one Intelligent Electronic Device (IED) in the electrical system to identify at least one event in the electrical system. The method also includes determining whether the electrical system is impacted by the at least one identified event, and in response to determining the electrical system is impacted by the at least one identified event, analyzing one or more characteristics related to the determined impact. At least one of recovery metric(s) and status(es) related to the analysis of the one or more impact characteristics may be presented on the at least one IED and/or on a display of at least one device in communication with the at least one IED. Additionally, at least one recommendation action may be provided to address, improve or optimize recovery in response to the at least one identified event.

### CROSS REFERENCE TO RELATED APPLICATION

This application claims the benefit of and priority to U.S. Provisional Application No. 63/395,651, filed on Aug. 5, 2022, which application was filed under 35 U.S.C. § 119(e) and is incorporated by reference herein in its entirety.

### FIELD

This disclosure relates generally to electrical energy/power system(s) (herein referred to as electrical system(s)), and more particularly, to systems and methods for providing event recovery information and data in an electrical system.

### BACKGROUND

When end-users lose power or experience an event that impacts their electrical system (and its operation), it is often critical for end-users to re-energize their loads quickly and restart their processes at the earliest possible opportunity (and with the least amount of time delay). The facility personal performing the work to restart the system/processes are generally out in the field in the proximity of the equipment they are trying to re-energize; not located in the office where the Edge Software (S/W) is being located and being reviewed (although both may also be working collectively). Because the analysis and possibly some remote aspects of restarting equipment are being performed in one location (at the Edge S/W or a remote control station) and the efforts to restart the equipment are often in a different location (in the field/plant), critical communication between the two parties to ensure a quick and efficient recovery is imperative; otherwise, miscommunication can lead to wasted time, confusion, indecision and even safety-related risks.

### SUMMARY

Disclosed herein are systems and methods for providing event recovery information and data in an electrical system. In particular, since it is likely as important (or more so in some cases) for personnel in the field to understand the status(es) and recovery progress than those in front of a computer screen, this invention provides recovery information at each capable discrete device installed in the electrical system and provides many benefits and improvements over current methods. For example, field personnel would be able to determine the recovery progress for all loads downstream from any one or more discrete IEDs so they could better determine the extent of issues remaining to be resolved. An event counter/timer could be provided at discrete IEDs to allow field personnel to quantify the duration of an ongoing event, allowing them to expedite where able or necessary. Another feature would be to optionally provide a visual or audible indication on IEDs (i.e., blinking LED, etc.) to allow field personnel to know the loads requiring attention. Through Edge S/W, it would also be possible to quickly indicate and/or route field personnel to other areas impacted by the event. This invention would ultimately reduce recovery time, focus recovery efforts, and provide a feedback loop to help field personnel more quickly resolve events and restart their systems.

In one example implementation of the disclosed invention, a method for providing event recovery information and data in an electrical system includes processing electrical measurement data from or derived from energy-related signals captured or derived by at least one Intelligent Electronic Device (IED) in the electrical system to identify at least one event (e.g., at least one Power Quality event) in the electrical system. The method also includes determining whether the electrical system is impacted by the at least one identified event, and in response to determining the electrical system is impacted by the at least one identified event, analyzing one or more characteristics related to the determined impact. At least one of recovery metric(s) and status(es) related to the analysis of the one or more impact characteristics may be presented on the at least one IED and/or on a display of at least one device (e.g., a mobile device) in communication with the at least one IED. Additionally, at least one recommendation action may be provided to address, improve or optimize recovery in response to the at least one identified event. The at least one recommendation action may include, for example, at least one of a recommendation to: energize one or more loads, de-energize one or more loads, start a process, stop a process, pause a process, provide statuses of one or more other parts of the process, system and/or facility, provide feedback regarding efforts to restore the system, provide warnings (safety), etc.

In accordance with some embodiments of this disclosure, the at least one of the recovery metric(s) and the status(es) include at least one of: event status, percentage of load recovered from the at least one identified event, emissions/sustainability impact, typical emissions/sustainability impact (baseline), recovery time, typical recovery time (baseline), recovery energy, recovery energy cost, typical recovery energy (baseline), typical recovery energy cost (baseline), event impact, recovered event impact, typical event impact (baseline), load types impacted, load types still impacted (not recovered), configurable operational impact per unit of time or energy, and safety-related concerns.

In one example implementation of the disclosed invention, the at least one of recovery the metric(s) and the status(es) may be communicated to at least one edge or cloud-based device. Additionally, in one example implementation of the disclosed invention, the at least one of the recovery metric(s) and the status(es) may be logged or stored for future analysis (e.g., as historical data). Further, in one example implementation of the disclosed invention, the at least one of the recovery metric(s) and the status(es) may be prioritized and presented on the at least one IED based on at least one of severity, priority, safety, impact to the operation, and location of the at least one identified event.

In one example implementation of the disclosed invention, determining whether the electrical system is impacted by the at least one identified event, includes: determining whether one or more alarms were triggered in the electrical system in response to the at least one identified event. Additionally, in one example implementation of the disclosed invention, the one or more characteristics related to the determined impact that are analyzed using the disclosed method include at least one of: pre-event and post-event power(s), pre-event and post-event power factor(s), pre-event and post-event voltage(s), pre-event and post-event current(s), and pre-event and post-event phase(s) impact. Further, in one example implementation of the disclosed invention, the at least one identified event is characterized as either an impactful event or a non-impactful event based on the determined impact of the at least one identified event.

In one example implementation of the disclosed invention, a recovery timer may be initiated to measure or quantity recovery time of the electrical system in response to the at least one identified event. For example, the recovery timer may be initiated in response to at least one of an alarm and a trigger. The recovery timer may also be triggered manually, triggered from a digital or analog status change, or by some other means or indication.

In one example implementation of the disclosed invention, the at least one IED may be communicatively coupled to at least one remote display device (e.g., an IED remote display). In addition to being coupled to the at least one IED, the at least one remote display device may be coupled to other systems, devices, software (e.g., Edge S/W), etc. associated with the electrical system and be configured to display information from the at least one IED and/or the other systems, devices, software (e.g., Edge S/W), etc.

In one example implementation of the disclosed invention, the above and below discussed at least one IED and/or the at least one remote display device may be associated with an Electrical Power Monitoring System (EPMS) responsible for measuring, capturing, monitoring and/or controlling one or more aspects of the electrical system. The at least one IED and/or the at least one remote display device may be positioned or located, for example, at one or more locations or points (e.g., metering points) in the electrical system. The electrical system may be associated with at least one load, process, building, facility, watercraft, aircraft, or other type of structure, for example.

In some embodiments, the above method may be implemented on one or more the IEDs, for example, on the at least one IED responsible for capturing or deriving the energy-related signals. Additionally, in some embodiments the above method may be implemented partially or fully remote from the IEDs, for example, in a gateway, a cloud-based system, on-site software, a remote server, etc. (which may alternatively be referred to as a “head-end” or “Edge” system herein). Examples of the IEDs may include a smart utility meter, a power quality meter, and/or another measurement device (or devices). The at least one IED may include breakers, relays, power quality correction devices, uninterruptible power supplies (UPSs), filters, and/or variable speed drives (VSDs), for example. Additionally, the at least one IED may include at least one virtual meter in some embodiments.

It is understood that the energy-related signals captured or derived by the at least one IED discussed above may include, for example, at least one of: a voltage signal, a current signal, input/output (I/O) data, and a derived or extracted value. In some embodiments, the I/O data includes at least one of a digital signal (e.g., two discrete states) and an analog signal (e.g., continuously variable). The digital signal may include, for example, at least one of on/off status(es), open/closed status(es), high/low status(es), synchronizing pulse and any other representative bi-stable signal. Additionally, the analog signal may include, for example, at least one of temperature, pressure, volume, spatial, rate, humidity, and any other physically or user/usage representative signal.

In accordance with some embodiments of this disclosure, the derived or extracted value includes at least one of a calculated, computed, estimated, derived, developed, interpolated, extrapolated, evaluated, and otherwise determined additional energy-related value from at least one of the measured voltage signal and/or the measured current signal. In some embodiments, the derived value additionally or alternatively includes at least one of active power(s), apparent power(s), reactive power(s), energy(ies), harmonic distortion(s), power factor(s), magnitude/direction of harmonic power(s), harmonic voltage(s), harmonic current(s), interharmonic current(s), interharmonic voltage(s), magnitude/direction of interharmonic power(s), magnitude/direction of sub-harmonic power(s), individual phase current(s), phase angle(s), impedance(s), sequence component(s), total voltage harmonic distortion(s), total current harmonic distortion(s), three-phase current(s), phase voltage(s), line voltage(s), spectral analysis and/or other similar/related parameters. In some embodiments, the derived value additionally or alternatively includes at least one energy-related characteristic, the energy-related characteristic including magnitude, direction, phase angle, percentage, ratio, level, duration, associated frequency components, energy-related parameter shape, and/or decay rate. In accordance with some embodiments of this disclosure, the derived or extracted value may be linked to at least one process, load(s) identification, etc., for example.

It is understood that the energy-related signals or waveforms captured or derived by the at least one IED may include (or leverage) substantially any electrical parameter derived from at least one of the voltage and current signals (including the voltages and currents themselves), for example. It is also understood that the energy-related signals or waveforms may be continuously or semi-continuously/periodically captured/recorded and/or transmitted and/or logged by the at least one IED, and power quality events may be detected/identified based on the energy-related signals.

In some embodiments, identifying events from electrical measurement data from or derived from the energy-related signals includes identifying power quality event types of the of the events in embodiments in which the events correspond to or include at least one power quality event. The power quality event types may include, for example, at least one of: a voltage sag, a voltage swell, a voltage or current transient, a temporary interruption, and voltage or current harmonic distortion. It is understood there are types of power quality events and there are certain characteristics of these types of power quality events. According to IEEE Standard 1159-2019, for example, as provided below, a voltage sag is a decrease to between 0.1 and 0.9 per unit (pu) in rms voltage or current at the power frequency for durations of 0.5 cycle to 1 min. Typical values are 0.1 to 0.9 pu. Additionally, according to IEEE Standard 1159-2019, a voltage swell is an increase in rms voltage or current at the power frequency for durations from 0.5 cycles to 1 min. It is understood that IEEE Standard 1159-2019 is one revision of one standards body's (IEEE in this case) way of defining/characterizing power quality events. It is understood there are other standards that define power quality categories/events as well, such as the International Electrotechnical Commission (IEC), American National Standards Institute (ANSI), etc., which may have different descriptions or power quality event types, characteristics, and terminology. In some embodiments, power quality events may be customized power quality events (e.g., defined by a user).

| | Typical spectral | | Typical | | Typical voltage | |
|---|---|---|---|---|---|---|
| Categories | content | | duration | | magnitude | |
| 1.0 Transients | | | | | | |
| 1.1 Impulsive | | | | | | |
| 1.1.1 Nanosecond | 5 | ns rise | <50 | ns | | |
| 1.1.2 Microsecond | 1 | μs rise | 50 ns-1 ms | | | |
| 1.1.3 Millisecond | 0.1 | ms rise | >1 | ms | | |
| 1.2 Oscillatory | | | | | | |
| 1.2.1 Low frequency | <5 | kHz | 0.3-50 | ms | 0-4 | pu^{a} |
| 1.2.2 Medium frequency | 5-500 | kHz | 20 | μs | 0-8 | pu |
| 1.2.3 High frequency | 0.5-5 | MHz | 5 | μs | 0-4 | pu |
| 2.0 Short-duration root-mean- | | | | | | |
| square (rms) variations | | | | | | |
| 2.1 Instantaneous | | | | | | |
| 2.1.1 Sag | | | 0.5-30 | cycles | 0.1-0.9 | pu |
| 2.1.2 Swell | | | 0.5-30 | cycles | 1.1-1.8 | pu |
| 2.2 Momentary | | | | | | |
| 2.2.1 Interruption | | | 0.5 cycles - 3 s | | <0.1 | pu |
| 2.2.2 Sag | | | 30 cycles - 3 s | | 0.1-0.9 | pu |
| 2.2.3 Swell | | | 30 cycles - 3 s | | 1.1-1.4 | pu |
| 2.2.4 Voltage Imbalance | | | 30 cycles - 3 s | | 2%-15% | |
| 2.3 Temporary | | | | | | |
| 2.3.1 Interruption | | | >3 s-1 min | | <0.1 | pu |
| 2.3.2 Sag | | | >3 s-1 min | | 0.1-0.9 | pu |
| 2.3.3 Swell | | | >3 s-1 min | | 1.1-1.2 | pu |
| 2.3.4 Voltage Imbalance | | | >3 s-1 min | | 2%-15% | |
| 3.0 Long duration rms variations | | | | | | |
| 3.1 Interruption, sustained | | | >1 | min | 0.0 | pu |
| 3.2 Undervoltages | | | >1 | min | 0.8-0.9 | pu |
| 3.3 Overvoltages | | | >1 | min | 1.1-1.2 | pu |
| 3.4 Current overload | | | >1 | min | | |
| 4.0 Imbalance | | | | | | |
| 4.1 Voltage | | | steady state | | 0.5-5% | |
| 4.2 Current | | | steady state | | 1.0-3.0% | |
| 5.0 Waveform distortion | | | | | | |
| 5.1 DC offset | | | steady state | | 0-0.1% | |
| 5.2 Harmonics | 0-9 | kHz | steady state | | 0-20% | |
| 5.3 Interharmonics | 0-9 | kHz | steady state | | 0-2% | |
| 5.4 Notching | | | steady state | | | |
| 5.5 Noise | broadband | | steady state | | 0-1% | |
| 6.0 Voltage fluctuations | <25 | Hz | intermittent | | 0.1-7% | |
| | | | | | 0.2-2 | Pₛₜ^{b} |
| 7.0 Power frequency variations | | | <10 | s | ±0.10 | Hz |

NOTE
These terms and categories apply to power quality measurements and are not to be confused with similar terms defined in IEEE Std 1366 ™-2012 [B30] and other reliability-related standards, recommended practices, and guides.
^{a}The quantity pu refers to per unit, which is dimensionless. The quantity 1.0 pu corresponds to 100%. The nominal condition is often considered to be 1.0 pu. In this table, the nominal peak value is used as the base for transients and the nominal rms value is used as the base for rms variations.
^{b}Flicker severity index Pₛₜ as defined in IEC 61000-4-15: 2010 [B17] and IEEE Std 1453 ™ [B31].

A system for providing event recovery information and data in an electrical system is also disclosed herein. In one example implementation of the disclosed invention, the system includes at least one processor and at least one memory device coupled to the at least one processor. The at least one processor and the at least one memory device may be configured to process electrical measurement data from or derived from energy-related signals captured or derived by at least one IED in the electrical system to identify at least one event in the electrical system. Additionally, the at least one processor and the at least one memory device may be configured to determine whether the electrical system is impacted by the at least one identified event, a response to determining the electrical system is impacted by the at least one identified event, analyze one or more characteristics related to the determined impact. At least one of recovery metric(s) and status(es) related to the analysis of the one or more impact characteristics may be presented on the at least one IED and/or on a display of at least one device in communication with the at least one IED. Additionally, at least one recommendation action may be provided to address, improve or optimize recovery and/or safety in response to the at least one identified event.

In one example implementation of the disclosed invention, the system is or includes one or more components of an EPMS. The EPMS may be responsible, for example, for monitoring electrical signals, data derived from electrical signals, and/or controlling one or more aspects of the electrical system.

In a further aspect of the disclosed invention, a method for reducing power quality event impact is provided. The method for reducing power quality event impact may include, for example, processing electrical measurement data from energy-related signals captured or derived by at least one IED in an electrical system to identify at least one power quality event associated with at least one load monitored by the at least one IED. The at least one IED and the at least one load may be installed at respective locations in the electrical system, for example. An impact of the at least one identified power quality event on one or more of the at least one load may be determined, the at least one identified power quality event and the determined impact of the at least one identified power quality event may be used to provide at least one of a distinctive dashboard, report, procedure, and recommendation associated with the one or more of the at least one load. The at least one of the distinctive dashboard, report, procedure, and recommendation may characterize at least one aspect of the effects associated with certain power quality events, for example. In accordance with some embodiments of this disclosure, at least one action affecting at least one component of the electrical system may be performed in response to the characterization of the at least one aspect of the effects associated with the certain power quality events.

In accordance with some embodiments of this disclosure, the characterization of the at least one aspect of the effects associated with the certain power quality events characterizes at least one of: recovery time, recovery emissions, recovery impact, recovery energy, recovery source, operational efficiency, safety and location. Additionally, in accordance with some embodiments of this disclosure, the energy-related signals captured or derived by the at least one IED include at least one of: voltage(s), current(s), energy(ies), active power(s), apparent power(s), reactive power(s), harmonic voltage(s), harmonic current(s), total voltage harmonic distortion, total current harmonic distortion, harmonic power(s), discrete phase current(s), three-phase currents, phase voltage(s), line voltage(s) and power factor(s).

A system for reducing power quality event impact is also disclosed herein. In one aspect, the system for reducing power quality event impact includes at least one processor and at least one memory device (e.g., local and/or remote memory device) coupled to the at least one processor. The at least one processor and the at least one memory device may be configured to process electrical measurement data from energy-related signals captured or derived by at least one IED in an electrical system to identify at least one power quality event associated with at least one load monitored by the at least one IED. The at least one IED and the at least one load may be installed at respective locations in the electrical system, for example. An impact of the at least one identified power quality event on one or more of the at least one load may be determined, the at least one identified power quality event and the determined impact of the at least one identified power quality event may be used to provide at least one of a distinctive dashboard, report, procedure, and recommendation associated with the one or more of the at least one load. The at least one of the distinctive dashboard, report, procedure, and recommendation may characterize at least one aspect of the effects associated with certain power quality events, for example. In accordance with some embodiments of this disclosure, at least one action affecting at least one component of the electrical system may be performed in response to the characterization of the at least one aspect of the effects associated with the certain power quality events.

In accordance with some embodiments of this disclosure, the system is, includes, or is provided as part of an EPMS. In accordance with some embodiments of this disclosure, the at least one action is automatically performed in response to a control signal generated by the system in response to the characterization of the at least one aspect of the effects associated with the certain power quality events. The control signal may be generated by a control device in the system, for example.

In accordance with some embodiments of this disclosure, the at least one of the distinctive dashboard, report, procedure, and recommendation is provided on at least one interface or output. The at least one interface or output may include, for example, at least one of: an interface of a user device, a display device, a printer, and an interface of the at least one IED. In some example implementations, the at least one of the distinctive dashboard, report, procedure, and recommendation is context-based. For example, the electrical system may be associated with one or more segments, and the at least one of the distinctive dashboard, report, procedure, and recommendation may be provided based on the context of the one or more segments.

In accordance with some embodiments of this disclosure, the at least one of the distinctive dashboard, report, procedure, and recommendation is provided to at least one of: an end-user, equipment manufacturer, services team, other interested individual or party, or to another system for automated response/corrective action.

In some embodiments, the at least one IED capturing or deriving the energy-related signal includes at least one metering device. The at least one metering device may correspond, for example, to at least one metering device in the electrical system for which the energy-related signals are being captured/monitored.

As used herein, an IED is a computational electronic device optimized to perform a particular function or set of functions. Examples of IEDs may include smart utility meters, power quality meters, microprocessor relays, digital fault recorders, and other metering devices. IEDs may also be imbedded in VSDs, uninterruptible power supplies (UPSs), circuit breakers, relays, transformers, or any other electrical apparatus. IEDs may be used to perform measurement/monitoring and control functions in a wide variety of installations. The installations may include utility systems, industrial facilities, warehouses, office buildings or other commercial complexes, campus facilities, computing co-location centers, data centers, power distribution networks, or any other structure, process or load that uses electrical energy. For example, where the IED is an electrical power monitoring device, it may be coupled to (or be installed in) an electrical power transmission or distribution system and configured to sense/measure and store data (e.g., waveform data, logged data, I/O data, etc.) as electrical parameters representing operating characteristics (e.g., voltage, current, waveform distortion, power, etc.) of the electrical distribution system. These parameters and characteristics may be analyzed by a user to evaluate potential performance, reliability and/or power quality-related issues, for example. The IED may include at least a controller (which in certain IEDs can be configured to run one or more applications simultaneously, serially, or both), firmware, a memory, a communications interface, and connectors that connect the IED to external systems, devices, and/or components at any voltage level, configuration, and/or type (e.g., AC, DC). At least certain aspects of the monitoring and control functionality of an IED may be embodied in a computer program that is accessible by the IED.

In some embodiments, the term “IED” as used herein may refer to a hierarchy of IEDs operating in parallel and/or tandem/series. For example, an IED may correspond to a hierarchy of energy meters, power meters, and/or other types of resource meters. The hierarchy may comprise a tree-based hierarchy, such a binary tree, a tree having one or more child nodes descending from each parent node or nodes, or combinations thereof, wherein each node represents a specific IED. In some instances, the hierarchy of IEDs may share data or hardware resources and may execute shared software. It is understood that hierarchies may be non-spatial such as billing hierarchies where IEDs grouped together may be physically unrelated.

It is understood that an input is data that a processor and/or IED (e.g., the above-discussed plurality of IEDs) receives, and an output is data that a processor and/or IED sends. Inputs and outputs may either be digital or analog. The digital and analog signals may be both discrete variables (e.g., two states such as high/low, one/zero, on/off, etc. If digital this may be a value. If analog, the presence of a voltage/current may be considered by the system/IED as an equivalent signal) or continuous variables (e.g., continuously variable such as spatial position, temperature, pressure voltage, etc.). They may be digital signals (e.g., measurements in an IED coming from a sensor producing digital information/values) and/or analog signals (e.g., measurements in an IED coming from a sensor producing analog information/values). These digital and/or analog signals may include any processing step within the IED (e.g., derive a Power Factor, a magnitude, among all the derived calculations).

Processors and/or IEDs may convert/reconvert digital and analog input signals to a digital representation for internal processing. Processors and/or IEDs may also be used to convert/reconvert internally processed digital signals to digital and/or analog output signals to provide some indication, action, or other response (such as an input for another processor/IED). Typical uses of digital outputs may include opening or closing breakers or switches, starting or stopping motors and/or other equipment, and operating other devices and equipment that are able to directly interface with digital signals. Digital inputs are often used to determine the operational status/position of equipment (e.g., is a breaker open or closed, etc.) or read an input synchronous signal from a utility pulsed output. Analog outputs may be used to provide variable control of valves, motors, heaters, or other loads/processes in energy management systems. Finally, analog inputs may be used to gather variable operational data and/or in proportional control schemes.

A few more examples where digital and analog I/O data are leveraged may include (but not be limited to): turbine controls, plating equipment, fermenting equipment, chemical processing equipment, telecommunications, equipment, precision scaling equipment, elevators and moving sidewalks, compression equipment, waste water treatment equipment, sorting and handling equipment, plating equipment temperature/pressure data logging, electrical generation/transmission/distribution, robotics, alarm monitoring and control equipment, as a few examples.

As noted earlier in this disclosure, the energy-related signals captured/measured by the plurality of IEDs may include I/O data. It is understood that the I/O data may take the form of digital I/O data, analog I/O data, or a combination digital and analog I/O data. The I/O data may convey status information, for example, and many other types of information, as will be apparent to one of ordinary skill in the art from discussions above and below.

It is understood that the terms “processor” and “controller” are sometimes used interchangeably herein. For example, a processor may be used to describe a controller. Additionally, a controller may be used to describe a processor.

It is understood that there are many features, advantages and aspects associated with the disclosed invention, as will be apparent to one of ordinary skill in the art. Among other key benefits, the disclosed invention provides for:
More accessible data for field personnel;
More relevant information closer to the point of need;
Faster and/or better decision making;
Decreased confusion between field maintenance and systems operations personnel;
Readily available recovery metrics and baselines;
Distributed recovery data (as needed) from other IEDs to improve recovery efficiency; and
Improved safety by providing accessible information related to equipment and system status(es).

Other example features, advantages and aspects associated with the disclosed invention will be further appreciated from the discussions below.

### BRIEF DESCRIPTION OF THE DRAWINGS

The foregoing features of the disclosure, as well as the disclosure itself may be more fully understood from the following detailed description of the drawings, in which:

FIG. 1 shows an example electrical system in accordance with embodiments of the disclosure;

FIG. 2 illustrates examples of where data could be analyzed and event recovery information may be determined or learned in accordance with embodiments of the disclosure;

FIG. 2A shows an example electrical system with Intelligent Electronic Devices (IEDs) installed, for example, for capturing and analyzing data associated with the electrical system;

FIG. 3 shows an example IED that may be used in an electrical system and provided in an electrical power monitoring system (EPMS) in accordance with embodiments of the disclosure;

FIG. 4 is a flowchart illustrating an example implementation of a method for providing event recovery information and data in an electrical system;

FIG. 5 shows an example basic screen for recovery time on an IED;

FIG. 6 shows an example widget in accordance with some embodiments of this disclosure that may be presented on an IED, for example;

FIG. 7 shows another example widget in accordance with some embodiments of this disclosure that may be presented on an IED, for example;

FIG. 8 shows a further example widget in accordance with some embodiments of this disclosure that may be presented on an IED, for example;

FIG. 9 shows another example widget in accordance with some embodiments of this disclosure that may be presented on an IED, for example; and

FIG. 10 shows example parameters of interest related to voltage events and event recovery.

### DETAILED DESCRIPTION

The features and other details of the concepts, systems, and techniques sought to be protected herein will now be more particularly described. It will be understood that any specific embodiments described herein are shown by way of illustration and not as limitations of the disclosure and the concepts described herein. Features of the subject matter described herein can be employed in various embodiments without departing from the scope of the concepts sought to be protected.

For convenience, certain introductory concepts and terms used in the specification (and adopted from IEEE Standard 1159-2019, for example) are collected here.

As used herein, the term “periodic event” is used to describe a non-random, non-arbitrary, planned, expected, intentional, or predicable electrical event. A periodic event typically occurs at regular or semi-regular intervals. It is understood that periodic waveforms may not be related to a particular electrical “event”. For example, the “steady state” operation of a system will produce waveforms with repeating or recurring values and noise (i.e., periodic waveforms).

As used herein, the term “aperiodic event” is used to describe a random, arbitrary, unplanned, unexpected, unintentional, or unpredicted electrical event (e.g., voltage sag, voltage swell, voltage transient, and even voltage interruption). An aperiodic event typically occurs non-cyclically, arbitrarily or without specific temporal regularity. For the sake of this disclosure, transients and voltage sags are considered to be aperiodic events (i.e., notching is deemed/considered a harmonic phenomenon).

As used herein, the term “instantaneous interruption” is used to describe a deviation to 0-10% of the nominal value for a duration of ½ cycle to 30 cycles.

As used herein, the term “momentary interruption” is used to describe a deviation to 0-10% of the nominal value for a duration of 30 cycles to 3 seconds.

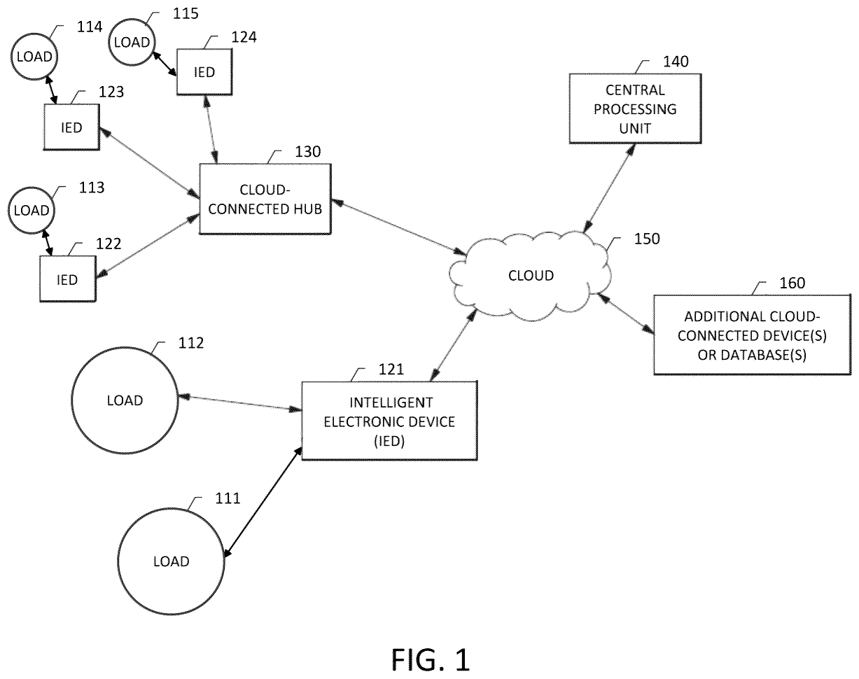

As used herein, the term “sag” (of which a “voltage sag” is one example) is used to describe a deviation to 10-90% of the nominal value, for example, for a duration of ½ cycle to 1 minute, as shown in FIG. 1.

As used herein, the term “short-duration rms variations” is used to describe a deviation from the nominal value with a duration of ½ cycle to 1 minute. Sub-categories of short-duration rms variations include instantaneous interruptions, momentary interruptions, temporary interruptions, sags and swells.

As used herein, the term “swell” is used to describe a deviation greater than 110% of the nominal value, for example, for a duration of ½ cycle to 1 minute, as shown in FIG. 1.

As used herein, the term “temporary interruption” is used to describe a deviation to 0-10% of the nominal value for a duration of 3 seconds to 1 minute.

As used herein, the term “transient” is used to describe a deviation of the voltage and/or current from the nominal value with a duration typically less than 1 cycle. Sub-categories of transients include impulsive (unidirectional polarity) and oscillatory (bidirectional polarity) transients.

In embodiments, there are four general qualities that determine the impact of energy-related transient events:
1. The nature, source, and/or energy associated with the transient(s),
2. The susceptibility of the system(s), process(es) and/or load(s) to the transient(s),
3. The effect of the system(s), process(es) and/or load(s) to the transient, and
4. The cost sensitivity to this effect.

Because each facility is unique (even within similar market segments), it is difficult to ascertain the extent to which several (or even one) voltage sags (or other power quality events) will impact a facility's operation. For example, it is possible for a voltage sag to significantly impact one facility's operation while the same voltage sag may have little or no noticeable impact on another facility's operation. It is also possible for a voltage sag to impact one part of a facility's electrical system differently than it does on another part of the same electrical system.

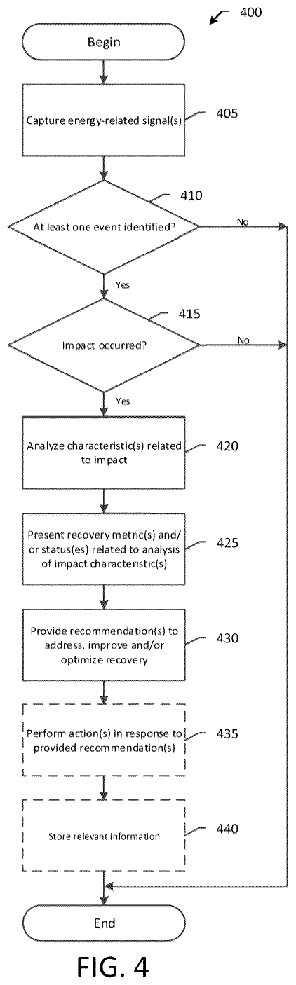

As briefly described in the Summary Section of this disclosure, and as will be further appreciated from discussions below, the disclosed invention provides event recovery information and data in an electrical system to reduce recovery time, focus recovery efforts, and provide a feedback loop to help field personnel more quickly resolve events and restart their systems. Additional aspects of the disclosed invention will be appreciated from discussions related to the figures, particularly FIGS. 4-10.

Referring to FIG. 1, an example electrical system in accordance with embodiments of the disclosure includes one or more loads (here, loads 111, 112, 113, 114, 115) (also sometimes referred to herein as “equipment” or “apparatuses”) and one or more intelligent electronic devices (IEDs) (here, IEDs 121, 122, 123, 124) capable of sampling, sensing or monitoring one or more parameters (e.g., power monitoring parameters) associated with the loads. In embodiments, the loads 111, 112, 113, 114, 115 and IEDs 121, 122, 123, 124 may be installed in one or more buildings or other physical locations or they may be installed on one or more processes and/or loads within a building. The buildings may correspond, for example, to commercial, industrial or institutional buildings.

As shown in FIG. 1, the IEDs 121, 122, 123, 124 are each coupled to one or more of the loads 111, 112, 113, 114, 115 (which may be located “upline” or “downline” from the IEDs in some embodiments). The loads 111, 112, 113, 114, 115 may include, for example, machinery or apparatuses associated with a particular application (e.g., an industrial application), applications, and/or process(es). The machinery may include electrical or electronic equipment, for example. The machinery may also include the controls and/or ancillary equipment associated with the equipment.

In embodiments, the IEDs 121, 122, 123, 124 may monitor and, in some embodiments, analyze parameters (e.g., energy-related parameters) associated with the loads 111, 112, 113, 114, 115 to which they are coupled. The IEDs 121, 122, 123, 124 may also be embedded within the loads 111, 112, 113, 114, 115 in some embodiments. According to various aspects, one or more of the IEDs 121, 122, 123, 124 may be configured to monitor utility feeds, including surge protective devices (SPDs), trip units, active filters, lighting, IT equipment, motors, and/or transformers, which are some examples of loads 111, 112, 113, 114, 115, and the IEDs 121, 122, 123, 124, and may detect ground faults, voltage sags, voltage swells, momentary interruptions and oscillatory transients, as well as fan failure, temperature, arcing faults, phase-to-phase faults, shorted windings, blown fuses, and harmonic distortions, which are some example parameters that may be associated with the loads 111, 112, 113, 114, 115. The IEDs 121, 122, 123, 124 may also monitor devices, such as generators, including input/outputs (I/Os), protective relays, battery chargers, and sensors (for example, water, air, gas, steam, levels, accelerometers, flow rates, pressures, and so forth).

According to another aspect, the IEDs 121, 122, 123, 124 may detect overvoltage, undervoltage, or transient overvoltage conditions, as well as other parameters such as temperature, including ambient temperature. According to a further aspect, the IEDs 121, 122, 123, 124 may provide indications of monitored parameters and detected conditions that can be used to control the loads 111, 112, 113, 114, 115 and other equipment in the electrical system in which the loads 111, 112, 113, 114 and IEDs 121, 122, 123, 124 are installed. A wide variety of other monitoring and/or control functions can be performed by the IEDs 121, 122, 123, 124, and the aspects and embodiments disclosed herein are not limited to IEDs 121, 122, 123, 124 operating according to the above-mentioned examples.

It is understood that the IEDs 121, 122, 123, 124 may take various forms and may each have an associated complexity (or set of functional capabilities and/or features). For example, IED 121 may correspond to a “basic” IED, IED 122 may correspond to an “intermediate” IED, and IED 123 may correspond to an “advanced” IED. In such embodiments, intermediate IED 122 may have more functionality (e.g., energy measurement features and/or capabilities) than basic IED 121, and advanced IED 123 may have more functionality and/or features than intermediate IED 122. For example, in embodiments IED 121 (e.g., an IED with basic capabilities and/or features) may be capable of monitoring instantaneous voltage, current energy, demand, power factor, averages values, maximum values, instantaneous power, and/or long-duration rms variations, and IED 123 (e.g., an IED with advanced capabilities) may be capable of monitoring additional parameters such as voltage transients, voltage fluctuations, frequency slew rates, harmonic power flows, and discrete harmonic components, all at higher sample rates, etc. It is understood that this example is for illustrative purposes only, and likewise in some embodiments an IED with basic capabilities may be capable of monitoring one or more of the above energy measurement parameters that are indicated as being associated with an IED with advanced capabilities. It is also understood that in some embodiments the IEDs 121, 122, 123, 124 each have independent functionality.

In the example embodiment shown, the IEDs 121, 122, 123, 124 are communicatively coupled to a central processing unit 140 via the “cloud” 150. In some embodiments, the IEDs 121, 122, 123, 124 may be directly communicatively coupled to the cloud 150, as IED 121 is in the illustrated embodiment. In other embodiments, the IEDs 121, 122, 123, 124 may be indirectly communicatively coupled to the cloud 150, for example, through an intermediate device, such as a cloud-connected hub 130 (or a gateway), as IEDs 122, 123, 124 are in the illustrated embodiment. The cloud-connected hub 130 (or the gateway) may, for example, provide the IEDs 122, 123, 124 with access to the cloud 150 and the central processing unit 140. It is understood that not all IED's have a connection with (or are capable of connecting with) the cloud 150 (directly or non-directly). In embodiments is which an IED is not connected with the cloud 150, the IED may be communicating with a gateway, edge software or possibly no other devices (e.g., in embodiments in which the IED is processing data locally).

As used herein, the terms “cloud” and “cloud computing” are intended to refer to computing resources connected to the Internet or otherwise accessible to IEDs 121, 122, 123, 124 via a communication network, which may be a wired or wireless network, or a combination of both. The computing resources comprising the cloud 150 may be centralized in a single location, distributed throughout multiple locations, or a combination of both. A cloud computing system may divide computing tasks amongst multiple racks, blades, processors, cores, controllers, nodes or other computational units in accordance with a particular cloud system architecture or programming. Similarly, a cloud computing system may store instructions and computational information in a centralized memory or storage, or may distribute such information amongst multiple storage or memory components. The cloud system may store multiple copies of instructions and computational information in redundant storage units, such as a RAID array.

The central processing unit 140 may be an example of a cloud computing system, or cloud-connected computing system. In embodiments, the central processing unit 140 may be a server located within buildings in which the loads 111, 112, 113, 114, 115, and the IEDs 121, 122, 123, 124 are installed, or may be remotely-located cloud-based service. The central processing unit 140 may include computing functional components similar to those of the IEDs 121, 122, 123, 124 is some embodiments, but may generally possess greater numbers and/or more powerful versions of components involved in data processing, such as processors, memory, storage, interconnection mechanisms, etc. The central processing unit 140 can be configured to implement a variety of analysis techniques to identify patterns in received measurement data from the IEDs 121, 122, 123, 124, as discussed further below. The various analysis techniques discussed herein further involve the execution of one or more software functions, algorithms, instructions, applications, and parameters, which are stored on one or more sources of memory communicatively coupled to the central processing unit 140. In certain embodiments, the terms “function,” “algorithm,” “instruction,” “application,” or “parameter” may also refer to a hierarchy of functions, algorithms, instructions, applications, or parameters, respectively, operating in parallel and/or tandem. A hierarchy may comprise a tree-based hierarchy, such a binary tree, a tree having one or more child nodes descending from each parent node, or combinations thereof, wherein each node represents a specific function, algorithm, instruction, application, or parameter.

In embodiments, since the central processing unit 140 is connected to the cloud 150, it may access additional cloud-connected devices or databases 160 via the cloud 150. For example, the central processing unit 140 may access the Internet and receive information such as weather data, utility pricing data, or other data that may be useful in analyzing the measurement data received from the IEDs 121, 122, 123, 124. In embodiments, the cloud-connected devices or databases 160 may correspond to a device or database associated with one or more external data sources. Additionally, in embodiments, the cloud-connected devices or databases 160 may correspond to a user device from which a user may provide user input data. A user may view information about the IEDs 121, 122, 123, 124 (e.g., IED manufacturers, models, types, etc.) and data collected by the IEDs 121, 122, 123, 124 (e.g., energy usage statistics) using the user device. Additionally, in embodiments the user may configure the IEDs 121, 122, 123, 124 using the user device.

In embodiments, by leveraging the cloud-connectivity and enhanced computing resources of the central processing unit 140 relative to the IEDs 121, 122, 123, 124, sophisticated analysis can be performed on data retrieved from one or more IEDs 121, 122, 123, 124, as well as on the additional sources of data discussed above, when appropriate. This analysis can be used to dynamically control one or more parameters, processes, conditions or equipment (e.g., loads) associated with the electrical system.

In embodiments, the parameters, processes, conditions or equipment are dynamically controlled by a control system associated with the electrical system. In embodiments, the control system may correspond to or include one or more of the IEDs 121, 122, 123, 124 in the electrical system, central processing unit 140 and/or other devices within or external to the electrical system. One or more of the IEDs 121, 122, 123, 124 and/or other components in the above-discussed electrical system may additionally or alternatively be provided in or be associated with an Electrical Power Monitoring System (EPMS). The EPMS may include software, communications systems and devices, and/or cloud-based components, such as those discussed above, in some embodiments.

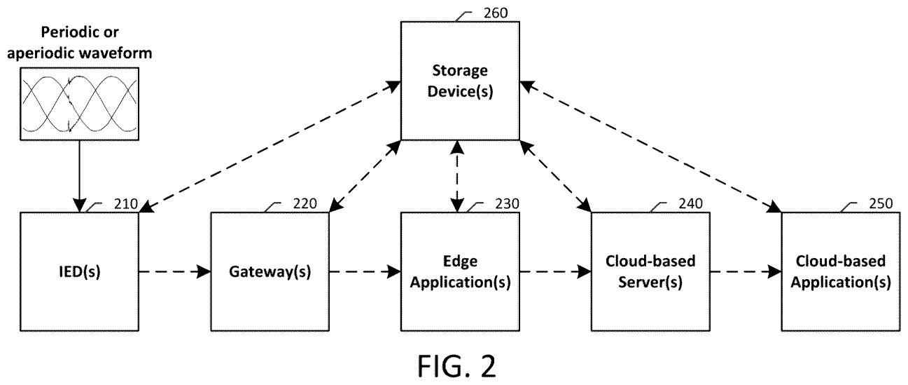

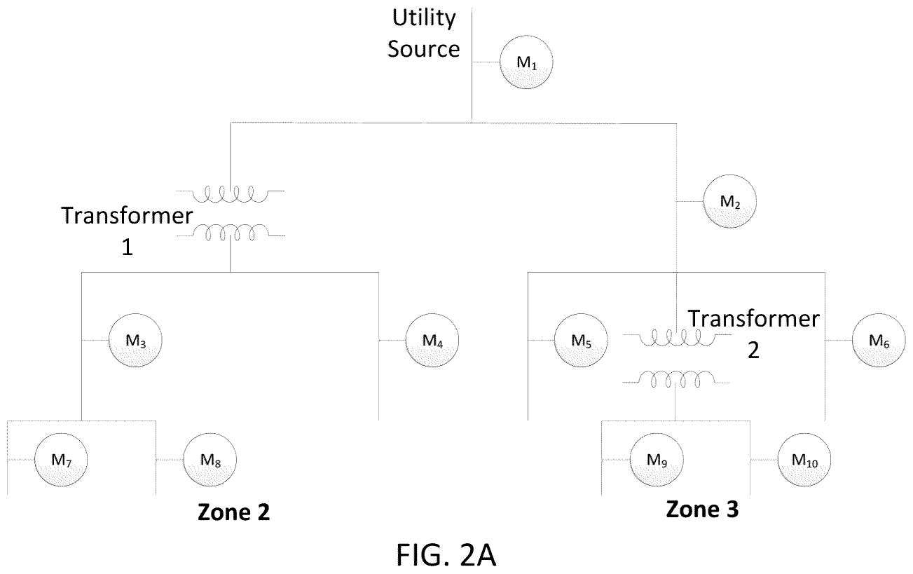

Referring to FIGS. 2 and 2A, FIG. 2 illustrates examples of where data (e.g., energy-related signals) could be analyzed and event recovery information may be determined or learned in accordance with embodiments of the disclosure. Additionally, FIG. 2A is a simplified single line diagram (SLD) showing an example electrical system with IEDs installed, for example, for capturing and analyzing data associated with the electrical system. The IEDs may be provided in or be associated with an EPMS in some instances. As illustrated in FIG. 2A, an electrical system may incorporate a diverse array of IEDs that are installed throughout the electrical system. These IEDs may have different levels of capabilities and feature sets; some more and some less. For example, energy consumers often install high-end (advanced capabilities) IEDs at the location where electrical energy enters their premises (M₁ in FIG. 2A). This is done to acquire the broadest and deepest understanding possible of the electrical signals' quality and quantity as received from the source (typically, the utility). Because the budget for metering may be fixed and the energy consumer often wants to meter as broadly as possible across their electrical system, economic practicality generally stipulates installing IEDs with lower capabilities as the installed metering points get closer to the loads. Because of this, the majority of facilities incorporate more low/mid-range IEDs than high-end IEDs.

“High-end” metering platforms (and some “mid-range” metering platforms) are more expensive and generally capable of capturing sophisticated PQ phenomena including high-speed voltage events. “Low-end” metering platforms are less expensive and generally have more limited processor bandwidth, sample rates, memory, and/or other capabilities as compared to high-end IEDs. The emphasis of low-end IEDs, including energy measurements taken in most breakers, UPSs, VSDs, etc., is typically energy consumption or other energy-related functions, and perhaps some very basic power quality phenomena (e.g., steady-state quantities such as imbalance, overvoltage, undervoltage, etc.). In short, an electrical system may incorporate a variety of IEDs, with each of the IEDs configured to monitor one or more aspects of the electrical system.

As shown in FIG. 2, captured energy-related signals, or energy-related waveforms (i.e., WFCs) associated with the captured energy-related signals, can be analyzed and event recovery information can be determined or learned on at least one IED 210, at least one gateway 220, at least one edge application 230, at least one cloud-based server 240, at least one cloud-based application 250 and/or at least one storage means 260. It is understood that the analysis of the captured energy-related signals could occur in one or more additional or alternative systems and devices other than those shown in FIG. 2. For example, while the system illustrated in FIG. 2 is shown as including at least one gateway 220, it is understood that in some instances the system may not include the at least one gateway 220. It is understood that in accordance with various aspects of this disclosure, the focus of the disclosed invention is on the analysis of the captured energy-related signals to determine or learn event recovery information; not so much where it occurs.

In accordance with some embodiments of this disclosure, the at least one IED 210 shown in FIG. 2 is configured to capture energy-related signals in the electrical system, and in some instances generated one or more energy-related waveform captures from the energy-related signals. For example, the at least one IED 210 may include at least one voltage and/or current measurement device configured to measure the voltage and/or current signals in the electrical system, and the at least one IED 210 may generate one or more energy-related signals from or using the measured voltage and/or current signals.

The energy-related signals captured by the at least one IED 210 may be analyzed on or using a variety of devices and/or techniques to determine or learn event recovery information. For example, as illustrated in FIG. 2, the at least one captured energy-related signal may be analyzed on or using one or more of the at least one IED 210, the at least one gateway 220, the at least one edge application 230, the at least one cloud-based server 240, the at least one cloud-based application 250 and the at least one storage means 260. For example, the at least one IED 210 may employ algorithms to determine or learn event recovery information. Alternatively, the waveform captured by the at least one IED 210 may be passed to a subsequent element (e.g., gateway 220, Edge application 230, Cloud-based application 250, etc.) for analysis to determine or learn event recovery information.

It is understood that the at least one storage means 260 may be located at any point in the system. For example, the at least one storage means 260 may be provided in, or be associated with, at least one of the at least one IED 210, the at least one gateway 220, the at least one edge application 230, the at least one cloud-based server 240, and the at least one cloud-based application 250 in some embodiments. In one example implementation, the energy-related signals and/or associated energy-related waveform captures could be stored in the at least one IED 210 and/or passed to the at least one edge application 230 for storage and so forth. It is understood that the at least one storage means 260 may additionally or alternatively be provided as or correspond to a storage means that is separate from the at least one IED 210, the at least one gateway 220, the at least one edge application 230, the at least one cloud-based server 240, and the at least one cloud-based application 250.

Additional aspects of analysis to determine or learn event recovery information will be appreciated from further discussions below.

It is understood that specific applications may use all of the elements, additional elements, different elements, or fewer elements shown in FIG. 2 and other figures to provide the same or similar results. For example, in one example implementation systems for analyzing, identifying and reducing extraneous WFCs in accordance with embodiments of the disclosure may not employ a gateway (e.g., 220) and/or cloud-based connection (e.g., to cloud-based server(s) and/or cloud-based application(s) such as 240, 250). Instead, the systems (e.g., EPMSs) may interconnect at least one IED (e.g., 210) with an Edge application (e.g., 240) via an Ethernet Modbus/TCP interconnection, for example.

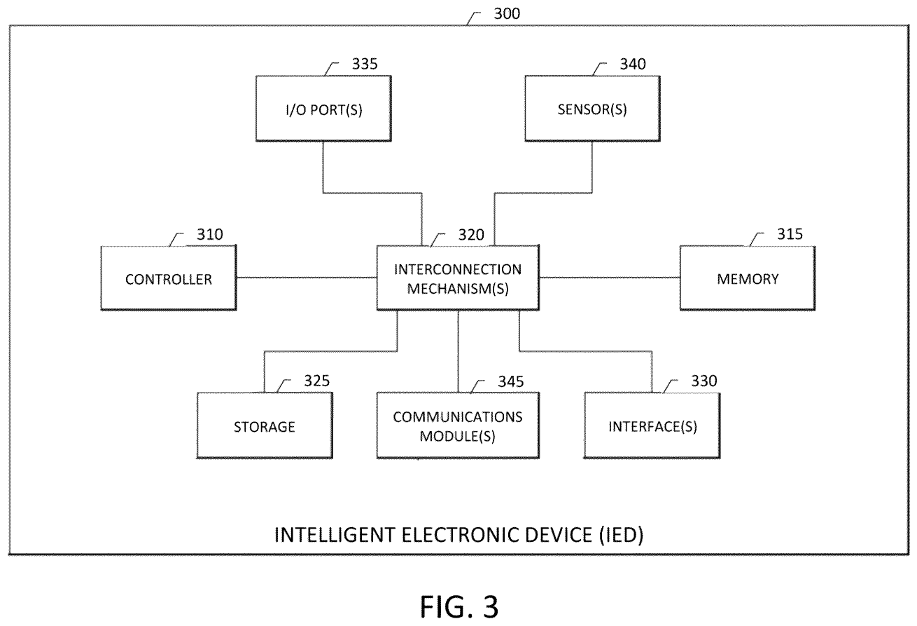

Referring to FIG. 3, an example IED 300 that may be suitable for use in the electrical system shown in FIG. 1, and/or the system shown in FIG. 2, for example, to capture, process, store and/or compress energy-related WFCs, includes a controller 310, a memory device 315, storage 325, and an interface 330. The IED 300 also includes an input-output (I/O) port 335, a sensor 340, a communication module 345, and an interconnection mechanism 320 for communicatively coupling two or more IED components 310-345.

The memory device 315 may include volatile memory, such as DRAM or SRAM, for example. The memory device 315 may store programs and data collected during operation of the IED 300. For example, in embodiments in which the IED 300 is configured to monitor or measure one or more electrical parameters associated with one or more loads (e.g., 111, shown in FIG. 1) in an electrical system, the memory device 315 may store the monitored electrical parameters.

The storage system 325 may include a computer readable and writeable nonvolatile recording medium, such as a disk or flash memory, in which signals are stored that define a program to be executed by the controller 310 or information to be processed by the program. The controller 310 may control transfer of data between the storage system 325 and the memory device 315 in accordance with known computing and data transfer mechanisms. In embodiments, the electrical parameters monitored or measured by the IED 300 may be stored in the storage system 325.

The I/O port 335 can be used to couple loads (e.g., 111, shown in FIG. 1) to the IED 300, and the sensor 340 can be used to monitor or measure the electrical parameters associated with the loads. The I/O port 335 can also be used to coupled external devices, such as sensor devices (e.g., temperature and/or motion sensor devices) and/or user input devices (e.g., local or remote computing devices) (not shown), to the IED 300. The external devices may be local or remote devices, for example, a gateway (or gateways). The I/O port 335 may further be coupled to one or more user input/output mechanisms, such as buttons, displays, acoustic devices, etc., to provide alerts (e.g., to display a visual alert, such as text and/or a steady or flashing light, or to provide an audio alert, such as a beep or prolonged sound) and/or to allow user interaction with the IED 300.

The communication module 345 may be configured to couple the IED 300 to one or more external communication networks or devices. These networks may be private networks within a building in which the IED 300 is installed, or public networks, such as the Internet. In embodiments, the communication module 345 may also be configured to couple the IED 300 to a cloud-connected hub (e.g., 130, shown in FIG. 1), or to a cloud-connected central processing unit (e.g., 140, shown in FIG. 1), associated with an electrical system including IED 300.

The IED controller 310 may include one or more processors that are configured to perform specified function(s) of the IED 300. The processor(s) can be a commercially available processor, such as the well-known Pentium™, Core™, or Atom™ class processors available from the Intel Corporation. Many other processors are available, including programmable logic controllers. The IED controller 310 can execute an operating system to define a computing platform on which application(s) associated with the IED 300 can run.

In embodiments, the electrical parameters monitored or measured by the IED 300 may be received at an input of the controller 310 as IED input data, and the controller 310 may process the measured electrical parameters to generate IED output data or signals at an output thereof. In embodiments, the IED output data or signals may correspond to an output of the IED 300. The IED output data or signals may be provided at I/O port(s) 335, for example. In embodiments, the IED output data or signals may be received by a cloud-connected central processing unit, for example, for further processing (e.g., to identify, track and analyze power quality events), and/or by equipment (e.g., loads) to which the IED is coupled (e.g., for controlling one or more parameters associated with the equipment, as will be discussed further below). In one example, the IED 300 may include an interface 330 for displaying visualizations indicative of the IED output data or signals and/or for selecting configuration parameters (e.g., waveform capture and/or compression parameters) for the IED 300. The interface 330 may correspond to a graphical user interface (GUI) in embodiments.

Components of the IED 300 may be coupled together by the interconnection mechanism 320, which may include one or more busses, wiring, or other electrical connection apparatus. The interconnection mechanism 320 may enable communications (e.g., data, instructions, etc.) to be exchanged between system components of the IED 300.

It is understood that IED 300 is but one of many potential configurations of IEDs in accordance with various aspects of the disclosure. For example, IEDs in accordance with embodiments of the disclosure may include more (or fewer) components than IED 300. Additionally, in embodiments one or more components of IED 300 may be combined. For example, in embodiments memory 315 and storage 325 may be combined.

It is understood that energy-related signal captures, such as may be captured by IED 300, for example, are high-speed measurements and recordings that can be triggered using many methods including: manually, automatically after exceeding one or more parameter threshold(s), periodically (e.g., at 12:00 pm daily), initiated by an external input (e.g., change in digital status input signal), or by some other means. The invention disclosed herein, as will be appreciated from further discussions below, automatically analyzes the energy-related signals to determine or learn event recovery information.

Referring to FIG. 4, a flowchart (or flow diagram) is shown to illustrate an example method (here, method 400) of the disclosure relating to providing event recovery information and data in an electrical system. Rectangular elements (typified by element 405 in FIG. 4), as may be referred to herein as “processing blocks,” may represent computer software and/or IED algorithm instructions or groups of instructions. Diamond shaped elements (typified by element 410 in FIG. 4), as may be referred to herein as “decision blocks,” represent computer software and/or IED algorithm instructions, or groups of instructions, which affect the execution of the computer software and/or IED algorithm instructions represented by the processing blocks. The processing blocks and decision blocks (and other blocks shown) can represent steps performed by functionally equivalent circuits such as a digital signal processor circuit or an application specific integrated circuit (ASIC).

The flowchart does not depict the syntax of any particular programming language. Rather, the flowchart illustrates the functional information one of ordinary skill in the art requires to fabricate circuits or to generate computer software to perform the processing required of the particular apparatus. It should be noted that many routine program elements, such as initialization of loops and variables and the use of temporary variables are not shown. It will be appreciated by those of ordinary skill in the art that unless otherwise indicated herein, the particular sequence of blocks described is illustrative only and can be varied. Thus, unless otherwise stated, the blocks described below are unordered; meaning that, when possible, the blocks can be performed in any convenient or desirable order including that sequential blocks can be performed simultaneously (e.g., run parallel on multiple processors and/or multiple IEDs) and vice versa. Additionally, the order/flow of the blocks may be rearranged and/or interchanged in some cases as well. It will also be understood that various features from the flowchart described below may be combined in some embodiments. Thus, unless otherwise stated, features from the flowchart described below may be combined with other features described herein and/or apparent to one of skill in the art, for example, to capture the various advantages and aspects of systems and methods associated with providing event recovery information and data in an electrical system. It is also understood that various features from the flowchart described below may be separated in some embodiments. For example, while the flowchart illustrated in FIG. 4 is shown having many blocks, in some embodiments the method shown by the flowchart may include fewer blocks or steps.

Referring to FIG. 4, a flowchart illustrates an example method 400 for providing event recovery information and data in an electrical system. In accordance with some embodiments of this disclosure, method 400 may be implemented on a processor of at least one IED (e.g., 121, shown in FIG. 1) in the electrical system and/or remote from the at least one IED, for example, in at least one of: a cloud-based system, on-site/edge software, a gateway, or another head-end system.

As illustrated in FIG. 4, the method 400 begins at block 405, where at least one energy-related signal is captured/measured using at least one IED in an electrical system. The at least one IED may be installed or located, for example, at a respective metering point of a plurality of metering points in the electrical system. In some embodiments, the at least one IED may be coupled to one or more loads/equipment/apparatuses (e.g., induction motors, variable speed drives, etc.) in the electrical system, and the at least one energy-related signal captured by the at least one IED may be associated with the operation of the loads/equipment/apparatuses to which the at least one IED is coupled. It is understood that the at least one energy-related signal may be associated with one or more corresponding energy-related waveform captures. For example, in accordance with some embodiments of this disclosure, energy-related waveform captures may be generated from the at least one energy-related signal captured or measured by the at least one IED. More detailed definitions and examples of the at least one energy-related signal (e.g., voltage and/or current signal(s)) are described in the Summary Section of this disclosure, for example.

It is understood that the at least one energy-related signal capture occurring at block 405 may be initiated automatically (e.g., in response to a control signal or automatic trigger), semi-automatically and/or in response to user-input (e.g., a manual trigger) in some embodiments, or initiated by exceeding the threshold of some parameter. For example, the at least one IED may be configured to take or perform periodic and/or aperiodic signal/waveform captures. In accordance with some embodiments of this disclosure, waveform captures are grouped into one of two categories: “aperiodic” and “periodic” waveform captures. Aperiodic waveform captures originate from at least one of a random, arbitrary, unplanned, unexpected, unintentional, or unpredicted event (e.g., voltage sag, voltage swell, voltage transient, and even voltage interruption), often using determined or pre-determined thresholds to trigger the capture, of voltage and/or current signal(s). They may also be triggered by external inputs such as I/O status changes, crossing the thresholds of one or more external sensors, or by some other arbitrary or pseudo-arbitrary condition. Periodic waveform captures come from at least one of a non-random, non-arbitrary, planned, expected, timed, intentional, or predicable actions to request, induce, generate or force a steady-state waveform capture of the voltage and/or current signal(s).

At block 410, electrical measurement data from or derived from the at least one energy-related signal captured or derived by the at least one IED at block 405 is processed, and it is determined if at least one event in the electrical system has been identified. In accordance with some embodiments of this disclosure, the at least one identified event is indicative of at least one anomalous condition in the electrical system. As will be further appreciated from discussions below, the at least one anomalous condition may result in load loss, equipment failure, etc. in the electrical system. In some example implementations or situations, the at least one anomalous condition may include a power quality event. The power quality event may include, for example, at least one of: a voltage sag, a voltage swell, and a voltage transient. The power quality event may be characterized, for example, based on the definitions set forth in IEEE Standard 1159-2019 (or newer revision). It is understood that IEEE Standard 1159-2019 is one standards body's (IEEE in this case) approach to defining/characterizing power quality events. It is understood there are other standards (and revisions) that define power quality categories/events as well, such as the International Electrotechnical Commission (IEC), American National Standards Institute (ANSI), etc., which may have different descriptions or power quality event types, characteristics, and terminology. In some embodiments, power quality events may be customized power quality events (e.g., defined by a user).

It is understood that the energy-related data processed to identify the at least one event in the electrical system may include other types of data in addition to the data from or derived from the at least one energy-related signal measured or captured at block 405 in some instances. For example, it is contemplated that the energy-related data may further include at least one of I/O data, user-input data, PLC data, etc., with one or more of these types of data being used to identify the at least one event in the electrical system.

At block 415, it is determined whether the electrical system is impacted by the at least one event identified at block 410. Because each electrical system is unique, it is understood that certain events may impact one electrical system and its respective loads while not impacting (or impacting differently) another electrical system and its respective loads. In particular, as previously noted, electrical systems typically include a plurality of loads with each of the loads having respective operating characteristics, electrical characteristics and ratings, functions, and so forth. It follows that the electrical systems may behave differently in response to events, such as the above-discussed at least one identified event, depending on the types, sensitivities and configurations of the loads, etc.

In one example implementation of the disclosed invention, it may be determined whether the electrical system is impacted by the at least one identified event by determining whether one or more alarms were triggered in the electrical system in response to the at least one identified event. In other words, triggered alarms may be indicative of the electrical system being impacted by the at least one identified event.

In accordance with some embodiments of this disclosure, at least one of measured magnitude and measured duration of the at least one identified event may be compared to at least one of a reference magnitude and a reference duration to determine impact of the at least one identified event on loads and/or zones associated with the electrical system. In response to determining that the impact exceeds an impact threshold, for example, it may be determined that part and/or all of the electrical system and/or its loads are affected by the identified at least one occurrence of the event. Some loads and/or zones, for example, may be more susceptible to energy-related issues/events than other loads and/or zones. In accordance with some embodiments of this disclosure, the loads may be automatically grouped into zones, for example, based upon historic analysis of recoveries in the past, customer segment type(s), etc. The zones may be used, for example, in analysis of how electrical hierarchy is constructed in customer facility.

In instances in which the electrical system is determined to be impacted by the at least one identified event (e.g., in response to triggered alarms being detected), the at least one identified event may be classified as an impactful event (or impactful events) on the electrical system. Additionally, in instances in which the electrical system is determined to be not impacted by the at least one identified event, the at least one identified event may be classified as a non-impactful event (or non-impactful events) on the electrical system.

If it is determined the electrical system is impacted by the at least one identified event, the method may proceed to block 420. Alternatively, if it is determined the electrical system is not impacted by the at least one identified event, the method may end in some embodiments or return to block 405 (e.g., for capturing and analyzing additional energy-related signals).

At block 420, one or more characteristics related to the determined impact are analyzed. The one or more characteristics related to the determined impact may include, for example, at least one of: pre-event and post-event power(s), pre-event and post-event power factor(s), pre-event and post-event voltage(s), pre-event and post-event current(s), and pre-event and post-event phase(s) impact.

In accordance with some embodiments of this disclosure, the one or more characteristics related to the determined impact are analyzed to identify or compute at least one of recovery metric(s) and status(es) associated with the electrical system's recovery from the at least one identified event. The at least one of the recovery metric(s) and the status(es) may include, for example, at least one of: event status, percentage of load recovered from the at least one identified event, emissions/sustainability impact, typical emissions/sustainability impact (baseline), recovery time, typical recovery time (baseline), recovery energy, recovery energy cost, typical recovery energy (baseline), typical recovery energy cost (baseline), event impact, recovered event impact, typical event impact (baseline), load types impacted, load types still impacted (not recovered), and configurable operational impact per unit of time or energy.

In one example implementation, a recovery timer may be initiated to measure or quantify recovery time of the electrical system in response to the at least one identified event. The recovery timer may be initiated, for example, manually, automatically, from an I/O status(es) change, etc.

At block 425, one or more of the recovery metrics related to the analysis of the one or more impact characteristics are presented on the at least one IED and/or on a display of at least one device (e.g., a mobile device) in communication with the at least one IED. For example, as shown in FIG. 5, which illustrates one example screen of an IED, the presented recovery metrics may indicate “Recovery in Progress”, % load recovered, recovery duration, and typical recovery duration. The metrics may also indicate unproductive recovery energy consumed, CO2 emissions from recovery energy, costs associated with the event, and so forth. In one example implementation, the recovery metrics may be prioritized and presented based on at least one of severity, priority, safety, impact to the operation, and location of the at least one identified event. Additionally, in one example implementation, the recovery metric(s) are logged or stored for future analysis (e.g., as historical data). The recovery metric(s) may additionally or alternatively be communicated to at least one edge or cloud-based device (e.g., for further processing).

It is understood that other example types of information may be provided on the at least one IED and/or on the display of at least one device in communication with the at least one IED. For example, customized information related to the at least one event, impact and the recovery of the electrical system, such as that which is shown in FIGS. 5-9, may be generated and presented. In accordance with embodiments of this disclosure, the ability to provide customized information related to the at least one event, impact and the recovery of the electrical system allows the end-user to better manage their electrical system through simplified investment decisions, reduced CAPEX and OPEX costs, identified and characterized issues and opportunities, improved event ride-though, and ultimately, higher productivity. With this in mind, several example event tools or widgets are provided herein.

A few important factors to be considered when leveraging the benefits or providing event tools or widgets for end-users are:
1. No two customers are exactly alike, and no two metering points are identical. The real-time and historical event (e.g., voltage event) information is uniquely customized and provided at the point where the metering data is collected on a specific electrical system.
2. This uniquely customized event information from the discrete metering point may be aggregated at a system, sub-system, process, or multi-load level/zone.
3. Data from events may be used for real-time and/or historical analysis applications.
4. Data from this invention may be analyzed and used to reduce the length of recovery times due to events, reduce energy consumed during a recovery from an event, reduce the emissions associated with the energy consumed during an event recovery, provide baselines, reduce event impact, identify sources, identify locations, identify fault types, identify and quantify event characteristics, identify lead generation opportunities, procedures, develop statistical information associated with one or more voltage events, and/or other uses described below.
5. As events are captured, the real-time and/or historical voltage event data (and associated outputs) may be continuously updated according to the unique response of the electrical system.
6. The invention described herein may be applied to any type of electrical system/any type of customer; it is not limited to a specific type of system.
7. The invention described herein may be applied for any voltage level and is not limited to a specific voltage level.
8. Data provided by the invention may be fixed and/or auto-scaled.

There are a multitude of new features and numerous benefits that can be provided to end-users using the disclosed event tools or widgets. The ultimate goal of these features is to simplify a generally complex topic into actionable opportunities. Several features related to this idea are disclosed herein. While reference is made to voltage events, it is understood that other types of events may utilize the below discussed event tools or widgets.

### Real-time Event Widgets for Optimizing and Resolving Impactful Voltage Events

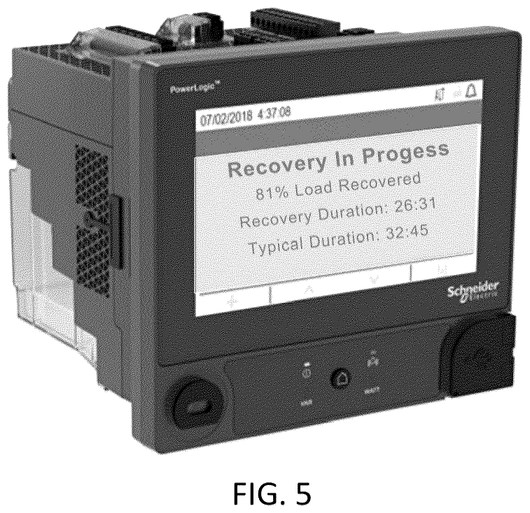

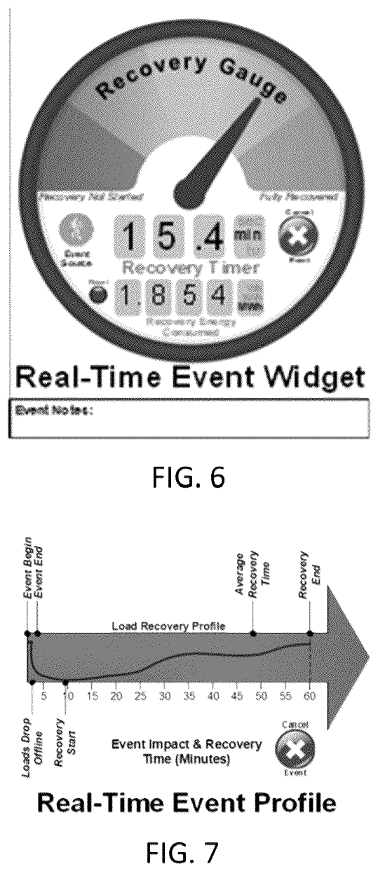

The first exemplary real-time widget disclosed herein is the “Avoidance of Voltage Events in Real-Time” (AVERT) widget. One example of this widget is shown in FIG. 6. This widget may contain several features to help end-users minimize the impact of a voltage event including:
Graduated Recovery Gauge
Recovery Timer
Recovery Energy
Event Source (upline/downline)
Event Type
Event Impact
Event Location
Event Notes
Event Cancel
Timer Reset
Energy Reset

The information contained in this widget may be used to monitor recovery from a voltage event in real-time and at a discrete location. It may also be an aggregation event data from single event taken from multiple devices.

A second exemplary real-time widget that can be used to reduce the impact from voltage events is a graph providing load profile information related to an event recovery (see FIG. 7). In this case, some features associated with the RT Event Profile may include:
Load Recovery Profile for Event
Event Start
Event End
Event Recovery Start
Event Recovery End
Event Impact & Recovery Duration
Fault Type
Voltage Event's Characteristics (e.g., magnitude, phase jump, etc.)
Average Event Recovery Time for Location
Recommendation/Prioritizations for Minimizing Event Impact to Operation
Cancel Event
Reset Load Profile

Baselines may also be superimposed on the load profile to provide indications/comparisons for improving voltage event recovery. Autoscaling may be used to automatically configure parameters under consideration. Moreover, a vertical scale may be used on the figure shown to provide an indication for the magnitude of recovery for the impact.

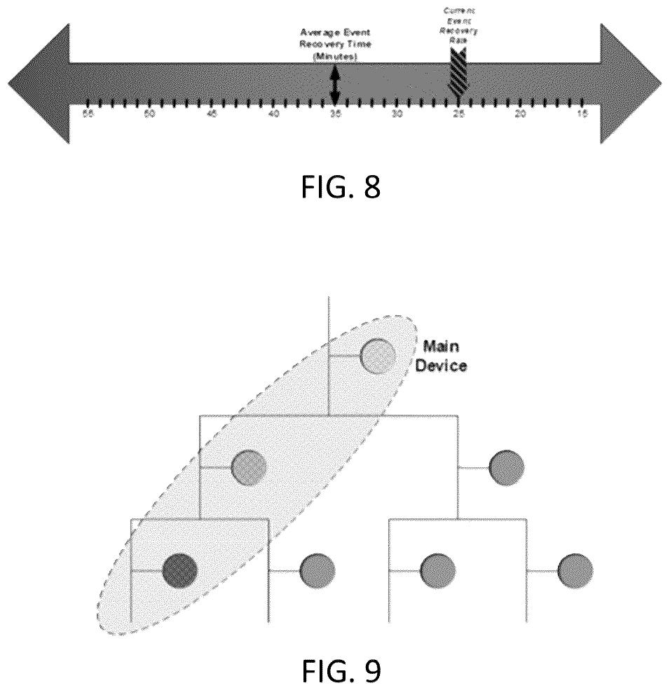

A third exemplary real-time widget for consideration is shown in FIG. 8. This widget can be used to provide a status of the real-time recovery performance versus the historical recovery performance. In this example, the baseline is provided in the center of the graph (i.e., at 35 minutes) while the estimated rate for recovery for the existing voltage event is shown as 25 minutes, which is an improvement of 10 minutes. Once the event recovery has concluded, the event metrics will be recorded and appropriately included in the historical data.

A fourth exemplary real-time widget for consideration is shown in FIG. 9. This figure is a hierarchical representation of a simple electrical system. In this example, an event has occurred, and load has been lost at the bottom-left circuit (indicated by the “red” metered point). The “green” metered points indicate load was not lost. The “orange” metered point indicates load was lost on some circuits, but not all circuits. The “lime” metered point at the top (i.e., Main Device) indicates that while load was lost, it was proportionately less (i.e., a smaller subset of the total load). As load recovers on the “red” metered point, the “red,” “orange,” and “lime” metered points all progress to “green” meaning the recovery is progress and nearing completion. While FIG. 9 illustrates a very simple drawing of an electrical system in recovery, there are additional features that may be included. For example, impact quantities, recovery times, recovery energies, emissions, baselines, and so forth may be included at discrete points in the system drawing. Zones and/or processes may be used instead of discrete metering points to provide recovery data to the end-user. Source locations and fault types may be included above or below one or more discrete locations within the drawing (e.g., event source upstream from Main Device, etc.).

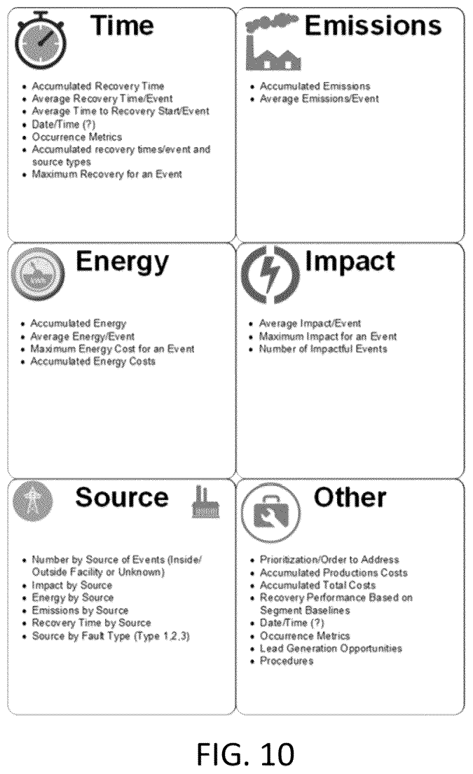

Widgets for historically analyzing voltage events may also be used as a tool to improve recovery and increase production. The basic blocks shown in FIG. 10 provide a simple list of parameters of interest related to voltage events and event recovery:
Time
Emissions
Energy
Impact
Source
Other

Each of these areas provide useful information for end-users to identify, analyze, optimize, mitigate and/or resolve voltage event issues, and each is briefly described below:

### Time

Accumulated Recovery Time—provides total recovery time/mode experienced by end-user since last reset. May be used to quantify the impact to productivity in an effort to bring a system/process/facility/circuit/load/etc. back on-line.

Average Recovery Time/Event—Provides a basic baseline of the average time to bring a system/process/facility/circuit/load(s)/etc. back on-line after a voltage event. This baseline may be used to develop performance indices, procedures or other tools to facility a faster resolution to voltage events.

Average Time to Recovery Start/Event—Provides a baseline of the average time it takes a system/process/facility/circuit/load(s)/etc. to start recovering after an event has occurred. Again, this baseline may be used to develop performance indices, procedures or other tools to facility a faster resolution to voltage events.

Data/Time of Occurrence—Facilitates understanding if a specific event cause is the source of the most impactful events. Some chronic voltage events correlate with a date (day, month, season, etc.) and/or time (morning, afternoon, evening, etc.), and this information would help characterize the problem temporally.

Accumulated Recovery Times/Event and Source Types—Further classifies event recoveries by source types. For example, whether utility sources OR internal sources are most responsible for the longest recoveries/event. This would allow the end-user to take steps to resolve the biggest problem.

Maximum Recovery for an Event—This metric provides scale of the problem (since the last reset) by providing the most severe voltage event within a facility or a business. It may also help prioritize resources to mitigate the issues.

Maximum Accrued Recovery Time by Device—The metric identifies the worst problem spot within a system to help prioritize resources to mitigate the issue.

### Emissions

Accumulated Emissions—Total accumulated emissions (since last reset) provide the total impact to the environment. May be proved in Ton CO₂ or by other gas, may be based on the geographic location of the facility (and the subsequent utility emissions), conversions of energy consumptions, and so forth.

Average Emissions/Event—Provides a basic baseline of the average emissions produced to bring a system/process/facility/circuit/load(s)/etc. back on-line after a voltage event. This baseline may be used to develop performance indices, procedures, reporting, and/or other tools to facility a faster resolution to voltage events.

### Energy

Accumulated Energy—Provides total accrued energy consumed during recovery period/mode as experienced by end-user since last reset. Used to quantify total energy consumed in effort to resume normal operation of system/process/facility/circuit/load/etc.

Average Energy/Event—Provides a simple baseline of the average energy consumed in effort to bring the system/process/facility/circuit/load(s)/etc. back on-line after a voltage event. This baseline may be used to develop performance indices, procedures or other tools to facility a faster resolution to voltage events

Maximum Energy Cost/Event—This metric identifies the largest energy consumption for a given event within a system to help prioritize resources to mitigate the issue.

Accumulated Energy Costs—Calculated from total accrued energy consumed to recovery from voltage event. Based on cost per kWh and/or demand charges associated with a recovery period.

### Impact

Average Impact/Event—Used to determine the average impact at a discrete one or more metering points per impactful event experienced (or per impactful/non-impactful event experienced). May be provided as an absolute value, relative value (percentage), or both.

Number of Impactful Events—Total accumulated number of events experienced (since the last reset) at one or more metering points.

Maximum Impact for an Event—This metric identifies the largest impact (as an absolute value, relative value (percentage) or both) experienced by the end-user for a given event within the system (one or more devices) to help prioritize resources to mitigate the issues.

### Source

Number by Source of Events—This disaggregates the data for the number of impactful or total voltage events by source location, which may be outside a facility, inside a facility, or an unknown location.

Impact by Source of Event—This disaggregates the data for the impact of one or more voltage events by source location, which may be outside a facility, inside a facility, or an unknown location.

Energy by Source of Event—This disaggregates the data for the total accrued energy consumed due to voltage events by source location, which may be outside a facility, inside a facility, or an unknown location.

Emissions by Source of Event—This disaggregates the data for the total accumulated greenhouse gas emissions during the recovery from one or more voltage events by source location, which may be outside a facility, inside a facility, or an unknown location.

Recovery Time by Source of Event—This disaggregates the data for the total accrued recovery time due to voltage events by source location, which may be outside a facility, inside a facility, or an unknown location.

Source/Fault Type (Type 1,2,3)—This disaggregates the data for impactful or total voltage events by fault type due to voltage events by source location, which may be outside a facility, inside a facility, or an unknown location.

Other information

Prioritization/Order to Address—This feature uses one or more metrics provided above from at least one metering point to provide prioritization of resources (e.g., CapEx, OpEx, MaintEx, mitigation equipment, etc.) to mitigate impacts from voltage events.

Accumulated Productions Costs—Production costs over time, provided by recovery time×production losses per recorded event.

Accumulated Total Costs—Accumulated production costs+accumulated energy costs+accumulated miscellaneous costs

Recovery Performance Based on Segment Baselines—Comparison of one customer's recovery performance versus one or more different customer's recovery performance, typically in the same market segment.

Lead Generation—Provides recommendations to mitigate voltage events at one or more locations within an end-user's facility. May be based on the successful mitigation at another end-user's facility, successful mitigation using a specific type of equipment, successful mitigation at a specific location within a facility, or successful mitigation based on some other parameter or characteristic.

Additional characteristics, metrics, parameters, calculations, or combinations thereof may be considered to help end-users more efficiently resolve the effects and impacts of voltage events.

It is understood that while various colorings are sometimes described and illustrated as being used to distinguish recovery characteristics (e.g., times), other means (e.g., shadings, heat maps, sounds, etc.) may be used to indicate the same. It is also understood the widgets described herein may be customized by users, for example, to suite their particular application(s)/need(s). Additionally, the widgets may be context-based, for example, being generated based on customer segment type, etc. Other aspects and variations of the disclosed widgets and other features of this disclosure will be appreciated by one of ordinary skill in the art.

Returning now to method 400, at block 430, at least one recommendation action may be provided to address, improve or optimize recovery in response to the at least one identified event. In accordance with some embodiments of this disclosure, the at least one recommendation action is selected based on at least one of a variety of factors including, for example, cost, availability, time to implement, safety improvement(s), whether the solution(s) is/are hardware or software based, etc.

At block 435, which is optional in some instances, at least one action may be taken or performed in response to the at least one provided recommendation action. For example, in embodiment in which the at least one IED responsible for capturing the energy-related signals is part of an EPMS, the EPMS may control one or more aspects of the electrical system (i.e., an example at least one action) in response to the at least one provided recommendation action.

At block 440, which is optional in some embodiments, one or more types of relevant information may be stored, for example, for future use and/or analysis. For example, information collected in any of the blocks of method 400 (e.g., characteristic(s) related to the event, impact, recovery metric(s), action(s) taken, and/or status(es) related to analysis of impact characteristic(s), recommendation(s) to address, improve and/or optimize recovery, etc.) may be stored.

In embodiments in which relevant information is stored, it is understood that the relevant information may be stored locally (e.g., on at least one local storage device) and/or remotely (e.g., on cloud-based storage), for example, based on a user-configured preference. For example, a user may indicate their preference to store the relevant information locally and/or remotely in a user interface (e.g., of a user device), and the relevant information may be stored based on the user-configured preference. It is understood that the location(s) in which the relevant information is stored may be based on a variety of other factors including customer type(s)/segment(s), process(es), memory requirements, cost(s), etc.

It is also understood that the relevant information may be stored during any step of method 400 illustrated in FIG. 4. In other words, block 440 does not necessarily need to occur after block 435 as shown in FIG. 4. Rather, it may occur at one or more points during method 400.

Subsequent to block 440 (or blocks 410, 415, 430 or 435 depending on the implementation), the method may end in some embodiments. In other embodiments, the method may return to block 405 and repeat again (e.g., for capturing and analyzing additional energy-related signals). In some embodiments in which the method ends after block 440 (or blocks 410, 415, 430 or 435), the method may be initiated again in response to user input, automatically, periodically, and/or a control signal, for example.

It is understood that method 400 may include one or more additional blocks or steps in some embodiments, as will be apparent to one of ordinary skill in the art.

As will be appreciated by one of ordinary skill in the art, the systems and methods disclosed herein may be used to reduce recovery time, focus recovery efforts, and provide a feedback loop to help field personnel more quickly resolve events and restart their systems.

As described above and as will be appreciated by those of ordinary skill in the art, embodiments of the disclosure herein may be configured as a system, method, or combination thereof. Accordingly, embodiments of the present disclosure may be comprised of various means including hardware, software, firmware or any combination thereof.

It is to be appreciated that the concepts, systems, circuits, calculations, algorithms, processes, procedures and techniques sought to be protected herein are not limited to use in the example applications described herein (e.g., power monitoring system applications), but rather may be useful in substantially any application where it is desired to reduce extraneous WFCs. While particular embodiments and applications of the present disclosure have been illustrated and described, it is to be understood that embodiments of the disclosure not limited to the precise construction and compositions disclosed herein and that various modifications, changes, and variations can be apparent from the foregoing descriptions without departing from the spirit and scope of the disclosure as defined in the appended claims.

Having described preferred embodiments, which serve to illustrate various concepts, structures and techniques that are the subject of this patent, it will now become apparent to those of ordinary skill in the art that other embodiments incorporating these concepts, structures and techniques may be used. Additionally, elements of different embodiments described herein may be combined to form other embodiments not specifically set forth above.

Accordingly, it is submitted that that scope of the patent should not be limited to the described embodiments but rather should be limited only by the spirit and scope of the following claims.

What is claimed is:

1. A method for providing event recovery information and data in an electrical system, comprising:
processing electrical measurement data from or derived from energy-related signals captured or derived by at least one Intelligent Electronic Device (IED) in the electrical system to identify at least one event in the electrical system;
determining whether the electrical system is impacted by the at least one identified event;
in response to determining the electrical system is impacted by the at least one identified event, analyzing one or more characteristics related to the determined impact;
presenting at least one of recovery metric(s) and status(es) related to the analysis of the one or more impact characteristics on the at least one IED and/or on a display of at least one device in communication with the at least one IED; and
providing at least one recommendation action to address, improve or optimize recovery in response to the at least one identified event.

2. The method of claim 1, wherein the at least of the recovery metric(s) and the status(es) include at least one of: event status, percentage of load recovered from the at least one identified event, emissions/sustainability impact, typical emissions/sustainability impact (baseline), recovery time, typical recovery time (baseline), recovery energy, recovery energy cost, typical recovery energy (baseline), typical recovery energy cost (baseline), event impact, recovered event impact, typical event impact (baseline), load types impacted, load types still impacted (not recovered), and configurable operational impact per unit of time or energy.

3. The method of claim 1, wherein the at least one of the recovery metric(s) and the status(es) are communicated to at least one IED, edge, cloud-based, or remote display device.

4. The method of claim 1, wherein the at least one of the recovery metric(s) and the status(es) are logged or stored for future analysis.

5. The method of claim 1, wherein the at least one of the recovery metric(s) and the status(es) are prioritized and presented on the at least one IED based on at least one of severity, priority, safety, impact to the operation, and location of the at least one identified event.

6. The method of claim 1, wherein determining whether the electrical system is impacted by the at least one identified event, includes: determining whether one or more alarms were triggered in the electrical system in response to the at least one identified event.

7. The method of claim 1, wherein the one or more characteristics related to the determined impact include at least one of: pre-event and post-event power(s), pre-event and post-event power factor(s), pre-event and post-event voltage(s), pre-event and post-event current(s), and pre-event and post-event phase(s) impact.

8. The method of claim 1, wherein the at least one identified event is characterized as either an impactful event or a non-impactful event based on the determined impact of the at least one identified event.

9. The method of claim 1, further comprising: initiating a recovery timer to measure or quantity recovery time of the electrical system in response to the at least one identified event.

10. The method of claim 9, wherein the recovery timer is initiated automatically, manually, or by some status change.

11. The method of claim 1, wherein the at least one identified event includes at least one power quality event.

12. The method of claim 1, wherein the at least one device in communication with the at least one IED includes at least one mobile device.

13. The method of claim 1, wherein the at least one IED is associated with an Electrical Power Monitor System (EPMS) responsible for measuring, capturing, monitoring and/or controlling one or more aspects of the electrical system.

14. A system for providing event recovery information and data in an electrical system, comprising:
at least one processor;
at least one memory device coupled to the at least one processor, the at least one processor and the at least one memory device configured to:
process electrical measurement data from or derived from energy-related signals captured or derived by at least one Intelligent Electronic Device (IED) in the electrical system to identify at least one event in the electrical system;
determine whether the electrical system is impacted by the at least one identified event;
in response to determining the electrical system is impacted by the at least one identified event, analyzing one or more characteristics related to the determined impact;
present at least one of recovery metric(s) and status(es) related to the analysis of the one or more impact characteristics on the at least one IED and/or on a display of at least one device in communication with the at least one IED; and
provide at least one recommendation action to address, improve or optimize recovery in response to the at least one identified event.

15. The system of claim 14, wherein the system is or includes one or more components of an Electrical Power Monitoring System (EPMS).

16. The system of claim 15, wherein the EPMS is responsible for monitoring electrical signals, data derived from electrical signals, and/or controlling one or more aspects of the electrical system.

17. A method for reducing power quality event impact, comprising:
processing electrical measurement data from energy-related signals captured or derived by at least one intelligent electronic device (IED) in an electrical system to identify at least one power quality event associated with at least one load monitored by the at least one IED, wherein the at least one IED and the at least one load are installed at respective locations in the electrical system;
determining an impact of the at least one identified power quality event on one or more of the at least one load;
using the at least one identified power quality event and the determined impact of the at least one identified power quality event to provide at least one of a distinctive dashboard, report, procedure, and recommendation associated with the one or more of the at least one load, wherein the at least one of the distinctive dashboard, report, procedure, and recommendation characterizes at least one aspect of the effects associated with certain power quality events; and
automatically performing at least one action affecting at least one component of the electrical system in response to the characterization of the at least one aspect of the effects associated with the certain power quality events.

18. The method of claim 17, wherein the characterization of the at least one aspect of the effects associated with the certain power quality events characterizes at least one of: recovery time, recovery emissions, recovery impact, recovery energy, recovery source, operational efficiency, safety and location.

19. The method of claim 17, wherein the energy-related signals captured or derived by the at least one IED include at least one of: voltage(s), current(s), energy(ies), active power(s), apparent power(s), reactive power(s), harmonic voltage(s), harmonic current(s), total voltage harmonic distortion, total current harmonic distortion, harmonic power(s), discrete phase current(s), three-phase currents, phase voltage(s), line voltage(s) and power factor(s).

20. A system for reducing power quality event impact, comprising:
at least one processor;
at least one memory device (e.g., local and/or remote memory device)-coupled to the at least one processor, the at least one processor and the at least one memory device configured to:
process electrical measurement data from energy-related signals captured or derived by at least one intelligent electronic device (IED) in an electrical system to identify at least one power quality event associated with at least one load monitored by the at least one IED, wherein the at least one IED and the at least one load are installed at respective locations in the electrical system;
determine an impact of the at least one identified power quality event on one or more of the at least one load;
use the at least one identified power quality event and the determined impact of the at least one identified power quality event to provide at least one of a distinctive dashboard, report, procedure, and recommendation associated with the one or more of the at least one load, wherein the at least one of the distinctive dashboard, report, procedure, and recommendation characterizes at least one aspect of the effects associated with certain power quality events; and
automatically perform at least one action affecting at least one component of the electrical system in response to the characterization of the at least one aspect of the effects associated with the certain power quality events.

21. The system of claim 20, wherein the system is, includes or is provided as part of an Electrical Power Monitoring System (EPMS).

22. The system of claim 20, wherein the at least one action is automatically performed in response to a control signal generated by the system in response to the characterization of the at least one aspect of the effects associated with the certain power quality events.

23. The system of claim 22, wherein the control signal is generated by a control device in the system.

24. The system of claim 20, wherein the at least one of the distinctive dashboard, report, procedure, and recommendation is provided on at least one interface or output.

25. The system of claim 24, wherein the at least one interface or output includes at least one of: an interface of a user device, a display device, a printer, and an interface of the at least one IED.

26. The system of claim 20, wherein the at least one of the distinctive dashboard, report, procedure, and recommendation is context-based.

27. The system of claim 26, wherein the electrical system is associated with one or more segments, and the at least one of the distinctive dashboard, report, procedure, and recommendation is provided based on the context of the one or more segments.

28. The system of claim 20, wherein the at least one of the distinctive dashboard, report, procedure, and recommendation is provided to at least one of: an end-user, equipment manufacturer, services team, other interested individual or party, or to another system for automated response/corrective action.
